(19) United States
(12) Patent Application Publication
(10) Pub. No.: US 2026/0287771 A1
(43) Pub. Date: Sep. 24, 2026

(54) Methods and Systems for Generating Angle Dependent Imaging Condition for Multi-Parameter Elastic Full Waveform Inversion

(71) Applicant: BP Corporation North America Inc., Houston, TX (US)

(72) Inventor: Simon Luo, Houston, TX (US)

(73) Assignee: BP Corporation North America Inc., Houston, TX (US)

(21) Appl. No.: 19/573,220

(22) Filed: Mar. 20, 2026

Related U.S. Application Data
(60) Provisional application No. 63/774,887, filed on Mar. 20, 2025.

(51) Int. Cl. G01V 1/28; G01V 1/30

(52) U.S. Cl. CPC G01V 1/282; G01V 1/307; G01V 2210/67

(57) ABSTRACT

A method includes obtaining recorded seismic data; obtaining a current subsurface model that includes elastic full-waveform inversion (FWI) parameters; obtaining a source elastic wavefield and a receiver elastic wavefield based on the current subsurface model; calculating a source-receiver angle between a first propagation direction of the source elastic wavefield and a second propagation direction of the receiver elastic wavefield; determining a limited range of source-receiver angles for each of the elastic FWI parameters that minimizes coupling among the elastic FWI parameters; obtaining a scaled gradient direction of an elastic FWI objective function with respect to each of the elastic FWI parameters using the limited range of source-receiver angles for each of the elastic FWI parameters; updating the elastic FWI parameters based on the scaled gradient direction to obtain updated elastic FWI parameters; and inputting the updated elastic FWI parameters into the current subsurface model to update the current subsurface model.

### CROSS-REFERENCE TO RELATED APPLICATIONS

The present application claims priority to U.S. Provisional Application No. 63/774,887 filed on Mar. 20, 2025, and entitled, “METHODS AND SYSTEMS FOR GENERATING ANGLE DEPENDENT IMAGING CONDITION FOR MULTI-PARAMETER ELASTIC FULL WAVEFORM INVERSION,” which is hereby incorporated herein by reference in its entirety for all purposes.

### BACKGROUND

Seismic surveying is a geophysical technique used to investigate the subsurface structure of the Earth by sending shock waves or vibrations into the ground and analyzing the reflected waves. Seismic waves are reflected when they encounter boundaries between different layers of subsurface materials, such as rock, sediment, or fluid. These layers have different densities, which cause the seismic waves to change speed and direction upon encountering the boundary. When a seismic wave propagates through the Earth and strikes a boundary between materials of different densities, a part of the seismic wave energy is transmitted into the new layer and the remainder is reflected back toward the surface. The reflected seismic wave energy is observed at the surface as seismic data and may be studied to ascertain information about the subsurface region. For example, the observed seismic data may be used to construct a velocity model of the subsurface region which models the velocity of the seismic waves passing through the subsurface region so as to translate subsurface reflection points of the seismic waves to their true depth within the formation. Furthermore, the seismic data observed by the receivers may also be used to create an image or profile of the corresponding subsurface region. Interpretation of these seismic images may provide a description of composition, density, and depth of subsurface materials and aids in resource extraction, hazard assessment, and environmental impact studies of the subsurface.

### SUMMARY

In an embodiment, a method comprises (a) obtaining recorded seismic data; (b) obtaining a current subsurface model comprising elastic full-waveform inversion (FWI) parameters, wherein the elastic FWI parameters comprise one or more of a velocity of P-wave (V_{P}), a velocity of S-wave (V_{S}), or a density of the subsurface (ρ); (c) obtaining a source elastic wavefield and a receiver elastic wavefield based on the current subsurface model and the recorded seismic data; (d) calculating a source-receiver angle between a first propagation direction of the source elastic wavefield and a second propagation direction of the receiver elastic wavefield; (e) determining a limited range of source-receiver angles for each of the elastic FWI parameters that minimizes coupling among the elastic FWI parameters; (f) obtaining a scaled gradient direction of an elastic FWI objective function with respect to each of the elastic FWI parameters using the limited range of source-receiver angles for each of the elastic FWI parameters; (g) updating the elastic FWI parameters based on the scaled gradient direction to obtain updated elastic FWI parameters; and (h) inputting the updated elastic FWI parameters into the current subsurface model to update the current subsurface model. In some embodiments, before performing step (e), the method further comprises (i) performing a sensitivity analysis on each of the elastic FWI parameters with respect to source-receiver angles. In certain embodiments, after performing step (e) and before performing step (f), the method further comprises (j) adding, to each of the source elastic wavefield and the receiver elastic wavefield, a weighting function corresponding to the limited range of source-receiver angles to obtain an angle restricted source elastic wavefield and an angle restricted receiver elastic wavefield; and (k) obtaining, based on the angle restricted source elastic wavefield and the angle restricted receiver elastic wavefield, gradients corresponding to each of the elastic FWI parameters. In other embodiment, the method further comprises iteratively repeating, in sequential order, steps (b)-(k) for a fixed number of iterations. In some embodiments, the method further comprises iteratively repeating, in sequential order, steps (b)-(k) until the elastic FWI objective function reaches a predefined magnitude that is less than a threshold. In other embodiment, performing step (e) comprises selecting, for the limited range of source-receiver angles for V_{P}, first set of angles (θ_{P}) in a first range, selecting, for the limited range of source-receiver angles for V_{S}, second set of angles (θ_{S}) in a second range; and selecting, for the limited range of source-receiver angles for ρ, third set of angles (θ_{P}) in a third range, wherein the first range, the second range, and the third range are different angle ranges. In some embodiment, the method further comprises obtaining the first propagation direction and the second propagation direction based on an optical flow equation method. In other embodiment, the method further comprises obtaining the first propagation direction and the second propagation direction based on a fast Fourier Transform (FFT) method. In some other embodiment, the method further comprises obtaining the first propagation direction and the second propagation direction based on a Poynting vector method. In an embodiment, a computing system comprises a memory configured to store instructions; and one or more processors coupled to the memory and configured to execute the instructions to cause the computing system to (a) obtain recorded seismic data; (b) obtain a current subsurface model comprising elastic FWI parameters, wherein the elastic FWI parameters comprise one or more of a velocity of P-wave (V_{P}), a velocity of S-wave (V_{S}), or a density of the subsurface (ρ); (c) obtain a source elastic wavefield and a receiver elastic wavefield based on the current subsurface model and the recorded seismic data; (d) calculate a source-receiver angle between a first propagation direction of the source elastic wavefield and a second propagation direction of the receiver elastic wavefield; (e) determine a limited range of source-receiver angles for each of the elastic FWI parameters that minimizes coupling among the elastic FWI parameters; (f) obtain a scaled gradient direction of an elastic FWI objective function with respect to each of the elastic FWI parameters using the limited range of source-receiver angles for each of the elastic FWI parameters; (g) update the elastic FWI parameters based on the scaled gradient direction to obtain updated elastic FWI parameters; and (h) input the updated elastic FWI parameters into the current subsurface model to update the current subsurface model. In some embodiments, before performing step (e), the one or more processors are further configured to execute the instructions to cause the computing system to (i) perform a sensitivity analysis on each of the elastic FWI parameters with respect to source-receiver angles. In some embodiments, after performing step (e) and before performing step (f), the one or more processors are further configured to execute the instructions to cause the computing system to (j) add, to each of the source elastic wavefield and the receiver elastic wavefield, a weighting function corresponding to the limited range of source-receiver angles to obtain an angle restricted source elastic wavefield and an angle restricted receiver elastic wavefield; and (k) obtain, based on the angle restricted source elastic wavefield and the angle restricted receiver elastic wavefield, gradients corresponding to each of the elastic FWI parameters. In some embodiment, the one or more processors are further configured to execute the instructions to cause the computing system to iteratively repeat, in sequential order, steps (b)-(k) for a fixed number of iterations. In other embodiment, the one or more processors are further configured to execute the instructions to cause the computing system to iteratively repeat, in sequential order, steps (b)-(k) until the elastic FWI objective function reaches a predefined magnitude that is less than a threshold. In some embodiments, the one or more processors are further configured to execute the instructions to cause the computing system to select, for the limited range of source-receiver angles for V_{P}, first set of angles (θ_{P}) in a first range, select, for the limited range of source-receiver angles for V_{S}, second set of angles (θ_{S}) in a second range; and select, for the limited range of source-receiver angles for ρ, third set of angles (θ_{P}) in a third range, wherein the first range, the second range, and the third range are different angle ranges. In some embodiment, the one or more processors are further configured to execute the instructions to cause the computing system to obtaining the first propagation direction and the second propagation direction based on an optical flow equation method, an FFT method, or Poynting vector method. In an embodiment, a computer program product comprising computer-executable instructions that are stored on a non-transitory computer-readable medium and that, when executed by one or more processors, cause a computing system to (a) obtain recorded seismic data; (b) obtain a current subsurface model comprising elastic FWI parameters, wherein the elastic FWI parameters comprise a velocity of P-wave (V_{P}), a velocity of S-wave (V_{S}), and a density of the subsurface (ρ); (c) obtain a source elastic wavefield and a receiver elastic wavefield based on the current subsurface model and the recorded seismic data; (d) calculate a source-receiver angle between a first propagation direction of the source elastic wavefield and a second propagation direction of the receiver elastic wavefield; (e) determine a limited range of source-receiver angles for each of the elastic FWI parameters that minimizes coupling among the elastic FWI parameters; (f) obtain a scaled gradient direction of an elastic FWI objective function with respect to each of the elastic FWI parameters using the limited range of source-receiver angles for each of the elastic FWI parameters; (g) update the elastic FWI parameters based on the scaled gradient direction to obtain updated elastic FWI parameters; and (h) input the updated elastic FWI parameters into the current subsurface model to update the current subsurface model. In some embodiment, before performing step (e), the computer-executable instructions, when executed by the one or more processors, further cause the computing system to (i) perform a sensitivity analysis on each of the elastic FWI parameters with respect to source-receiver angles. In some other embodiment, after performing step (e) and before performing step (f), the computer-executable instructions, when executed by the one or more processors, further cause the computing system to (j) add, to each of the source elastic wavefield and the receiver elastic wavefield, a weighting function corresponding to the limited range of source-receiver angles to obtain an angle restricted source elastic wavefield and an angle restricted receiver elastic wavefield; and (k) obtain, based on the angle restricted source elastic wavefield and the angle restricted receiver elastic wavefield, gradients corresponding to each of the elastic FWI parameters. In other embodiment, the computer-executable instructions, when executed by the one or more processors, further cause the computing system to iteratively repeat, in sequential order, steps (b)-(k) for a fixed number of iterations or until the elastic FWI objective function reaches a predefined magnitude that is less than a threshold.

### BRIEF DESCRIPTION OF THE DRAWINGS

For a detailed description of various exemplary embodiments, reference will now be made to the accompanying drawings in which:

FIG. 1 is a flow chart of various processes that may be performed based on analysis of seismic data acquired via a seismic survey system according to various embodiments disclosed herein;

FIG. 2 is a schematic diagram of an embodiment of a system for performing a marine seismic survey according to various embodiments disclosed herein;

FIG. 3 is a schematic diagram of an embodiment of a system for performing a land-based seismic survey according to various embodiments disclosed herein;

FIG. 4 is a block diagram of an embodiment of a computing system that may perform operations described herein based on data acquired via the marine survey system of FIG. 2 and/or the land survey systems of FIG. 3 according to various embodiments described herein;

FIG. 5 depicts a subsurface model according to various embodiments described herein;

FIG. 6A depicts a radiation pattern for P-wave velocity as a function of the source-receiver angles in the elastic FWI process according to various embodiments described herein;

FIG. 6B depicts a radiation pattern for S-wave velocity as a function of the source-receiver angles in the elastic FWI process according to various embodiments described herein;

FIG. 6C depicts a radiation pattern for density as a function of the source-receiver angles in the elastic FWI process according to various embodiments described herein;

FIG. 7 is a flowchart of an embodiment of a method for generating angle dependent imaging conditions for multi-parameter elastic FWI according to various embodiments described herein; and

FIG. 8 is a flowchart of an embodiment of a method for generating angle dependent imaging conditions for multi-parameter elastic FWI according to various embodiments described herein.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in the interest of clarity and conciseness.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a particular axis (e.g., central axis of a body or a port), while the terms “radial” and “radially” generally mean perpendicular to a particular axis. For instance, an axial distance refers to a distance measured along or parallel to the axis, and a radial distance means a distance measured perpendicular to the axis. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

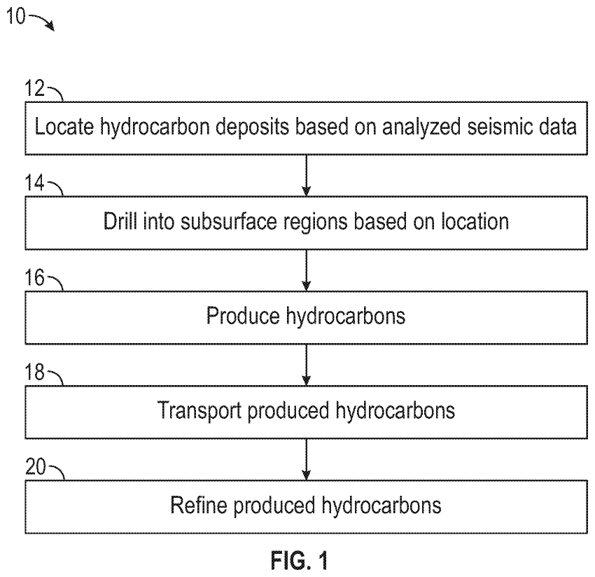

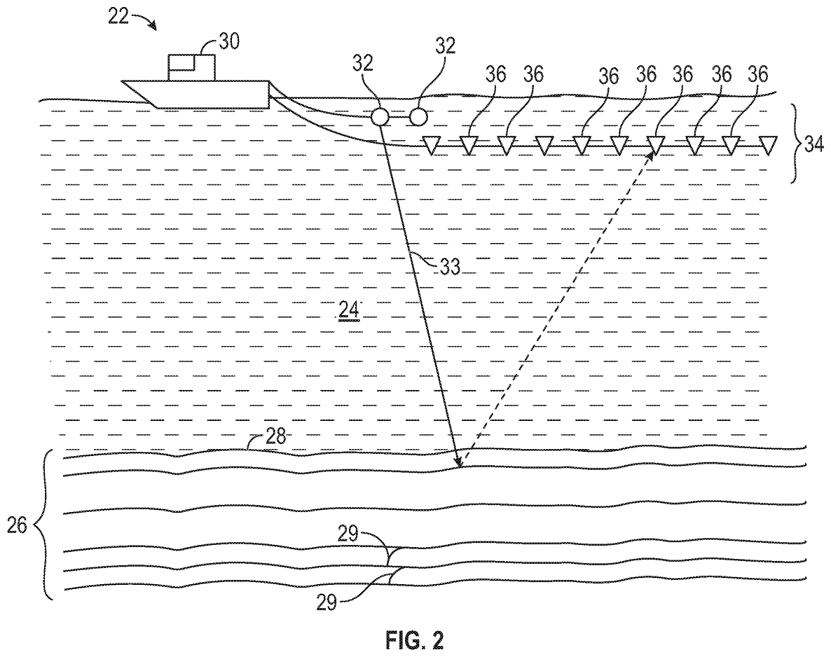

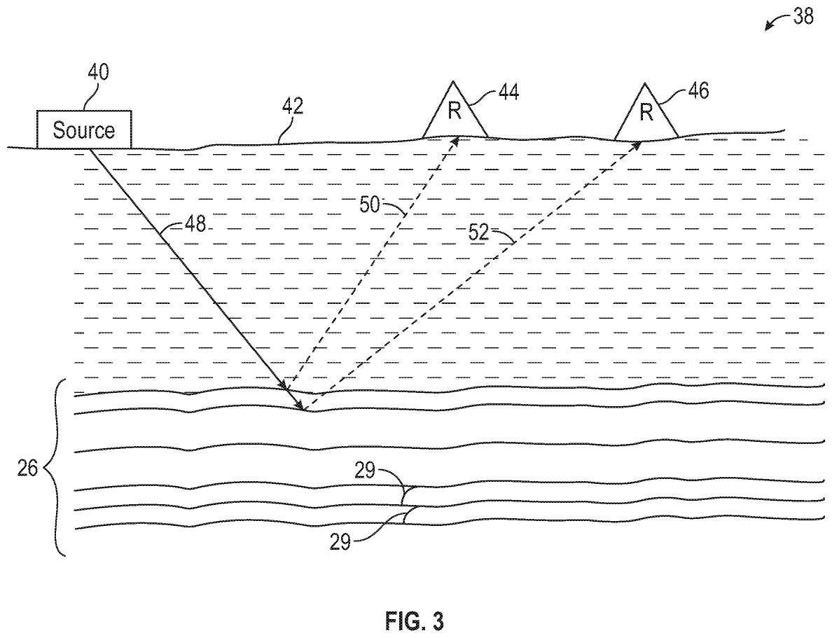

By way of introduction, seismic data may be acquired using a variety of seismic survey systems and techniques, two of which are discussed with respect to FIG. 2 and FIG. 3. Regardless of the seismic data gathering technique utilized, after the seismic data is acquired, a computing system may analyze the acquired seismic data and may use the results of the seismic data analysis (e.g., seismogram, map of geological formations, etc.) to perform various operations within the hydrocarbon exploration and production industries. For instance, FIG. 1 illustrates a flow chart of a method 10 that details various processes that may be undertaken based on the analysis of the acquired seismic data. Although the method 10 is described in a particular order, it should be noted that the method 10 may be performed in any suitable order.

Furthermore, source and receiver wavefields in seismic data are not inherently plane waves and exhibit spherical or more complex wave fronts, particularly near the source. However, both wavefields can be decomposed into plane waves using techniques like plane-wave decomposition, which isolates wave components traveling in specific directions and with particular velocities. This decomposition is especially useful for far-field propagation, where the wave fronts approximate plane waves, or for processing complex data in methods like migration and inversion. While near the source, the wavefields are generally spherical, decomposing them into plane waves simplifies the analysis and interpretation, particularly in cases involving multiple wave types or complex subsurface structures.

Referring now to FIG. 1, at block 12, locations and properties of hydrocarbon deposits within a subsurface region of the Earth associated with the respective seismic survey may be determined based on the analyzed seismic data. In one embodiment, the seismic data acquired may be analyzed to generate a map or profile that illustrates various geological formations within the subsurface region. Based on the identified locations and properties of the hydrocarbon deposits, at block 14, certain positions or parts of the subsurface region may be explored. That is, hydrocarbon exploration organizations may use the locations of the hydrocarbon deposits to determine locations at the surface of the subsurface region to drill into the Earth. As such, the hydrocarbon exploration organizations may use the locations and properties of the hydrocarbon deposits and the associated overburdens to determine a path along which to drill into the Earth, how to drill into the Earth, and the like.

After exploration equipment has been placed within the subsurface region, at block 16, the hydrocarbons that are stored in the hydrocarbon deposits may be produced via natural flowing wells, artificial lift wells, and the like. At block 18, the produced hydrocarbons may be transported to refineries and the like via transport vehicles, pipelines, and the like. At block 20, the produced hydrocarbons may be processed according to various refining procedures to develop different products using the hydrocarbons.

It should be noted that the processes discussed with regard to the method 10 may include other suitable processes that may be based on the locations and properties of hydrocarbon deposits as indicated in the seismic data acquired via one or more seismic survey. As such, it should be understood that the processes described above are not intended to depict an exhaustive list of processes that may be performed after determining the locations and properties of hydrocarbon deposits within the subsurface region.

With the foregoing in mind, FIG. 2 is a schematic diagram of a marine survey system 22 (e.g., for use in conjunction with block 12 of FIG. 1) that may be employed to acquire seismic data (e.g., waveforms) regarding a subsurface region of the Earth in a marine environment. Generally, a marine seismic survey using the marine survey system 22 may be conducted in an ocean 24 or other body of water over a subsurface region 26 of the Earth that lies beneath a seafloor 28.

The marine survey system 22 may include a vessel 30, one or more seismic sources 32, a (seismic) streamer 34, one or more (seismic) receivers 36, and/or other equipment that may assist in acquiring seismic images representative of geological formations within a subsurface region 26 of the Earth. The vessel 30 may tow the seismic source(s) 32 (e.g., an air gun array) that may produce energy, such as sound waves (e.g., seismic waveforms), that is directed at a seafloor 28. The vessel 30 may also tow the streamer 34 having a receiver 36 (e.g., hydrophones) that may acquire seismic waveforms that represent the energy output by the seismic source(s) 32 subsequent to being reflected off of various geological formations (e.g., salt domes, faults, folds, etc., represented schematically in FIG. 2 as subsurface reflectors 29) within the subsurface region 26. Additionally, although the description of the marine survey system 22 is described with one seismic source 32 (represented in FIG. 2 as an air gun array) and one receiver 36 (represented in FIG. 2 as a set of hydrophones), it should be noted that the marine survey system 22 may include multiple seismic sources 32 and multiple receivers 36. In the same manner, although the above descriptions of the marine survey system 22 is described with one seismic streamer 34, it should be noted that the marine survey system 22 may include multiple streamers similar to streamer 34. In addition, additional vessels 30 may include additional seismic source(s) 32, streamer(s) 34, and the like to perform the operations of the marine survey system 22.

FIG. 3 is a block diagram of a land survey system 38 (e.g., for use in conjunction with block 12 of FIG. 1) that may be employed to obtain information regarding the subsurface region 26 of the Earth in a non-marine environment. The land survey system 38 may include a land-based seismic source 40 and land-based receiver 44. In some embodiments, the land survey system 38 may include multiple land-based seismic sources 40 and one or more land-based receivers 44 and 46. Indeed, for discussion purposes, the land survey system 38 includes a land-based seismic source 40 and two land-based receivers 44 and 46. The land-based seismic source 40 (e.g., seismic vibrator) that may be disposed on a surface 42 of the Earth above the subsurface region 26 of interest. The land-based seismic source 40 may produce energy (e.g., sound waves, seismic waveforms) that is directed at the subsurface region 26 of the Earth. Upon reaching various geological formations (e.g., salt domes, faults, folds) within the subsurface region 26 the energy output by the land-based seismic source 40 may be reflected off of the geological formations (e.g., subsurface reflectors 29) and acquired or observed by one or more land-based receivers (e.g., 44 and 46).

In some embodiments, the land-based receivers 44 and 46 may be dispersed across the surface 42 of the Earth to form a grid-like pattern. As such, each land-based receiver 44 or 46 may receive a reflected seismic waveform in response to energy being directed at the subsurface region 26 via the seismic source 40. In some cases, one seismic waveform produced by the seismic source 40 may be reflected off of different geological formations and received by different receivers. For example, as shown in FIG. 3, the seismic source 40 may output energy that may be directed at the subsurface region 26 as seismic waveform 48. A first receiver 44 may receive the reflection of the seismic waveform 48 off of one geological formation and a second receiver 46 may receive the reflection of the seismic waveform 48 off of a different geological formation. As such, the first receiver 44 may receive a reflected seismic waveform 50 and the second receiver 46 may receive a reflected seismic waveform 52.

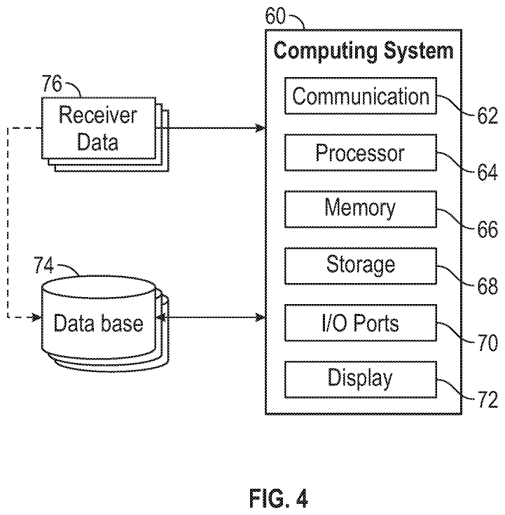

Regardless of how the seismic data is acquired, a computing system (e.g., for use in conjunction with block 12 of FIG. 1) may analyze the seismic waveforms acquired by the receivers 36, 44, 46 to determine seismic information regarding the geological structure, the location, and the properties of hydrocarbon deposits, and the like within the subsurface region 26. FIG. 4 is a block diagram of an example of such a computing system 60 that may perform various data analysis operations to analyze the seismic data acquired by the receivers 36, 44, 46 to determine the structure and/or predict seismic properties of the geological formations within the subsurface region 26.

Referring now to FIG. 4, the computing system 60 may include a communication component 62, a processor 64, memory 66, storage 68, input/output (I/O) ports 70, and a display 72. In some embodiments, the computing system 60 may omit one or more of the display 72, the communication component 62, and/or the I/O ports 70. The communication component 62 may be a wireless or wired communication component that may facilitate communication between the receivers 36, 44, 46, one or more databases 74, other computing devices, and/or other communication capable devices. In one embodiment, the computing system 60 may receive receiver data 76 (e.g., seismic data, seismograms, etc.) via a network component, the database 74, or the like. The processor 64 of the computing system 60 may analyze or process the receiver data 76 to ascertain various features regarding geological formations within the subsurface region 26 of the Earth.

The processor 64 may be any type of computer processor or microprocessor capable of executing computer-executable code. The processor 64 may also include multiple processors that may perform the operations described below. The memory 66 and the storage 68 may be any suitable articles of manufacture that can serve as media to store processor-executable code, data, or the like. These articles of manufacture may represent computer-readable media (e.g., any suitable form of memory or storage) that may store the processor-executable code used by the processor 64 to perform the presently disclosed techniques. The processor 64 may execute software applications that include programs that process seismic data acquired via receivers of a seismic survey according to the embodiments described herein.

With one or more embodiments, processor 64 can instantiate or operate in conjunction with one or more seismic inversion techniques. With another embodiment, the computing system 60 can be implemented by using neural networks. The one or more neural networks can be software-implemented or hardware-implemented. One or more of the neural networks can be a convolutional neural network.

The memory 66 and the storage 68 may also be used to store the data, analysis of the data, the software applications, and the like. The memory 66 and the storage 68 may represent non-transitory computer-readable media (e.g., any suitable form of memory or storage) that may store the processor-executable code used by the processor 64 to perform various techniques described herein. It should be noted that non-transitory merely indicates that the media is tangible and not a signal.

The I/O ports 70 may be interfaces that may couple to other peripheral components such as input devices (e.g., keyboard, mouse), sensors, I/O modules, and the like. I/O ports 70 may enable the computing system 60 to communicate with the other devices in the marine survey system 22, the land survey system 38, or the like via the I/O ports 70.

The display 72 may depict visualizations associated with software or executable code being processed by the processor 64. In one embodiment, the display 72 may be a touch display capable of receiving inputs from a user of the computing system 60. The display 72 may also be used to view and analyze results of the analysis of the acquired seismic data to determine the geological formations within the subsurface region 26, the location, and the properties of hydrocarbon deposits within the subsurface region 26, predictions of seismic properties associated with one or more wells in the subsurface region 26, and the like. The display 72 may be any suitable type of display, such as a liquid-crystal display (LCD), plasma display, or an organic light-emitting diode (LED) (or OLED) display, for example. In addition to depicting the visualization described herein via the display 72, it should be noted that the computing system 60 may also depict the visualization via other tangible elements, such as paper (e.g., via printing) and the like.

With the foregoing in mind, the present techniques described herein may also be performed using a supercomputer that employs multiple computing systems 60, a cloud-computing system, or the like to distribute processes to be performed across multiple computing systems 60. In this case, each computing system 60 operating as part of a super computer may not include each component listed as part of the computing system 60. For example, each computing system 60 may not include the display 72 since multiple displays 72 may not be useful to for a supercomputer designed to continuously process seismic data.

After performing various types of seismic data processing, the computing system 60 may store the results of the analysis in one or more databases 74. The databases 74 may be communicatively coupled to a network that may transmit and receive data to and from the computing system 60 via the communication component 62. In addition, the databases 74 may store information regarding the subsurface region 26, such as previous seismograms, geological sample data, seismic images, and the like regarding the subsurface region 26.

Although the components described above have been discussed with regard to the computing system 60, it should be noted that similar components may make up the computing system 60. Moreover, the computing system 60 may also be part of the marine survey system 22 or the land survey system 38, and thus may monitor and control certain operations of the seismic sources 32 or 40, the receivers 36, 44, 46, and the like. Further, it should be noted that the listed components are provided as example components and the embodiments described herein are not to be limited to the components described with reference to FIG. 4.

In some embodiments, the computing system 60 may generate a two-dimensional representation or a three-dimensional representation of the subsurface region 26 based on the seismic data received via the receivers mentioned above. Additionally, seismic data associated with multiple source/receiver combinations may be combined to create a near continuous profile of the subsurface region 26 that can extend for some distance. In a two-dimensional (2D) seismic survey, the receiver locations may be placed along a single line, whereas in a three-dimensional (3D) survey the receiver locations may be distributed across the surface in a grid pattern. As such, a 2D seismic survey may provide a cross sectional picture (vertical slice) of the Earth layers as they exist directly beneath the recording locations. A 3D seismic survey, on the other hand, may create a data “cube” or volume that may correspond to a 3D picture of the subsurface region 26.

In addition, a four-dimensional (4D) (or time-lapse) seismic survey may include seismic data acquired during a 3D survey at multiple times. Using the different seismic images acquired at different times, the computing system 60 may compare the two images to identify changes in the subsurface region 26.

In any case, a seismic survey may be composed of a very large number of individual seismic recordings or traces. As such, the computing system 60 may be employed to analyze the acquired seismic data to obtain an image representative of the subsurface region 26 and to determine locations and properties of hydrocarbon deposits. To that end, a variety of seismic data processing algorithms may be used to remove noise from the acquired seismic data, migrate the pre-processed seismic data, identify shifts between multiple seismic images, align multiple seismic images, and the like.

After the computing system 60 analyzes the acquired seismic data, the results of the seismic data analysis (e.g., seismogram, seismic images, map of geological formations, etc.) may be used to perform various operations within the hydrocarbon exploration and production industries. For instance, as described above, the acquired seismic data may be used to perform the method 10 of FIG. 1 that details various processes that may be undertaken based on the analysis of the acquired seismic data.

Seismic waves are reflected when they encounter boundaries between different layers of subsurface materials, such as rock, sediment, or fluid. These layers consisting of different materials may possess different subsurface properties such as P-wave velocity, S-wave velocity, and density, which cause the seismic waves to change speed and direction upon encountering the boundary. When a seismic wave propagates through the Earth and encounters a boundary between materials of different properties, a portion of the seismic wave energy may refract or transmit into the new layer while some energy may reflect back toward the surface. A portion of the total seismic wave energy is eventually observed and recorded near the Earth's surface as seismic data, and these data may then be analyzed to ascertain information about the subsurface region. For example, the observed seismic data may be used to construct a P-wave velocity model of the subsurface region, which describes the speed at which P-wave seismic energy propagates through the subsurface region. This velocity model may be further used to map the surface seismic data recorded as a function of time back to their true depth of origination within the subsurface formation. In this way, the seismic data observed by the receivers may be used to create an image or profile of the corresponding subsurface region. Interpretation of these seismic images provide a description of composition, material properties, and depths of subsurface structures to aid in resource extraction, hazard assessment, and environmental impact studies of the subsurface.

As described above, seismic surveys reflect seismic waves off of features in the subsurface regions of the Earth in order to collect information regarding the subsurface regions. The information collected from the reflected seismic waves may be used to create subsurface models that include velocity models and seismic images which may be used to identify subterranean features of interest such as, for example, hydrocarbon deposits. The subsurface models and seismic images may be used to identify locations of hydrocarbon deposits in the subsurface of the Earth and parameters for hydrocarbon exploration (e.g., path along which to drill into the subsurface of the Earth, speed and/or angle in which to drill into the subsurface of the Earth, and the like).

Seismic imaging usually includes a two-step process. First, a velocity model of the subsurface region is estimated. Then, seismic traces obtained from a seismic survey are combined with the estimated velocity model to generate an image of the subsurface structure using migration or imaging algorithms. As used herein, “migration” refers to a seismic data processing technique which shifts or relocates seismic reflections captured in the observed seismic data to or at least towards their true physical positions in the subsurface region to create an image. As used herein, “observed seismic data” refers to data that is captured by one or more seismic receivers as seismic signals that propagated through the subsurface region and which are originally generated by one or more corresponding sources. In some applications, an iterative data-fitting process such as an elastic FWI process may be applied to observed seismic data (e.g., seismic data collected using a seismic survey system such as survey systems 22 and 38) to form a model of subsurface properties such as P-wave velocity.

The elastic FWI process is an advanced geophysical technique used to image subsurface structures, providing high-resolution models of subsurface properties characterizing the Earth's interior. Unlike other seismic inversion methods, such as simpler acoustic FWI that simulates acoustic wavefields and utilizes P-wave energy, elastic FWI simulates and incorporates both compressional (P) and shear(S) wave energy in the inversion process. Therefore, through utilization of a more accurate model of the physics of seismic wave propagation, the elastic FWI approach enhances the resolution and accuracy of subsurface models, especially in complex geological settings where elastic effects are more significant.

The elastic FWI process is an optimization-based seismic imaging technique that attempts to iteratively minimize the difference (or misfit or residual) between observed seismic data and modeled seismic data generated from a subsurface model. Unlike methods that use simplified representations of the seismic wavefield, such seismic arrivals or travel times (e.g., travel-time inversion), elastic FWI is more capable of utilizing the full range of seismic waveforms recorded in the field. This results in more detailed and accurate models of the subsurface. The process uses a model of elastic moduli capable of incorporating all wave types, including both P-waves and S-waves, to better capture the full complexity of seismic wave propagation.

An elastic FWI process differs from acoustic FWI methods in that acoustic FWI uses a more limited set of parameters describe and model seismic wave propagation. More specifically, considering the isotropic case, acoustic FWI uses the P-wave velocity and density to model and invert the seismic data, whereas elastic FWI uses not only P-wave velocity and density, but also the S-wave velocity. This enables elastic FWI to model S-wave energy that is not accounted for with acoustic FWI. While the acoustic FWI process may be sufficient for environments where shear waves do not significantly affect wave propagation (e.g., marine environments consisting of simple geologic formations), elastic FWI may be better suited in complicated geologic settings as well as land-based areas where both P-waves and S-waves may be important for accurate imaging and understanding of subsurface properties.

The process of elastic FWI begins with data acquisition, where seismic data is collected using arrays of receivers such as receivers 36, 44, and 46 in FIGS. 2 and 3. This data may include a mix of P-wave and S-wave seismic energy. Next, a set of initial subsurface models that quantify and describe the P-wave velocity, S-wave velocity, density, and any additional parameters such as those for anisotropy are created based on prior geological knowledge or simplified inversion techniques. Using these initial subsurface models, modeled seismic data is generated through forward modeling, which solves the equations of motion for elastic wave propagation.

The difference between the observed/recorded seismic data and modeled seismic data is then calculated using a misfit function such as the least squares norm, which measures how well the modeled seismic data matches the recorded seismic data. The goal is to iteratively refine the subsurface model by minimizing this misfit through optimization algorithms, for example, using gradient-based methods. The model parameters, including P-wave and S-wave velocities and density, are adjusted at each step to reduce the misfit between recoded seismic data and the modeled seismic data.

The above process is repeated iteratively until the misfit reaches an acceptable level, resulting in a final subsurface model that provides high-resolution estimates of the geological parameters. These parameters may include P-wave and S-wave velocities, density, and other relevant elastic parameters, all of which contribute to a detailed image of the subsurface that is crucial for geological interpretation and exploration.

However, elastic FWI faces several challenges, one of which is the associated high computational cost. Solving complex elastic wave equations, which account for both P-waves and S-waves, may involve the use of a significant amount of computational resources. Furthermore, in an elastic media, parameters like P-wave velocity (Vp), S-wave velocity (Vs), and density (ρ) are not independent and are often related through empirical relationships or equations of state (such as an acoustic impedance, which is based on density (ρ) of a material and the speed of sound (v) in the same material). When one of the parameters like Vp, Vs, and ρ changes, the changed parameter may influence the other remaining parameters. For instance, a change in density might affect the velocities, and vice versa. Moreover, the set of parameters that most accurately models the seismic data to match the recorded data is often non-unique making it difficult to isolate the contribution of each parameter and separate them during the inversion process.

Furthermore, when elastic FWI parameters (e.g., Vp, Vs, and ρ) are treated as coupled, the parameter space that may have to be explored during the elastic FWI inversion process grows significantly. This increases the computational cost because more parameters may have to be optimized, and the inversion may become more prone to getting stuck in local minima, such that an accurate image of the subsurface may not be produced.

Since elastic FWI often uses iterative local optimization methods to minimize the difference between the recorded seismic data and modeled seismic data (or an elastic FWI objective function), the optimization becomes more complex with the coupled elastic FWI parameters (e.g., Vp, Vs, and ρ) because the gradient of the elastic FWI objective function with respect to each of the elastic FWI parameters (e.g., the spatial representation of how sensitive the misfit is to changes in the elastic model parameters) also becomes more complex. For example, a small change in one parameter may significantly affect the misfit and gradient with respect to other elastic FWI parameters, making the elastic FWI inversion process slower and more sensitive to initial guesses.

The present disclosure reduces the severity of the aforementioned technical problem of coupling among the elastic FWI parameters involved in the elastic FWI by providing a method for decoupling elastic FWI parameters using reflection angles. Here, the source elastic wavefields and the receiver elastic wavefields that are used to compute the gradient of the elastic FWI objective function with respect to model the elastic FWI parameters (e.g., Vp, Vs, and ρ) are restricted or constrained using the reflection angles. The term “reflection angle” as used herein may refer to half values of angles formed between incident seismic waves and the reflected seismic wave at the point of reflection, and these angles may be influenced by the elastic properties of the subsurface. Herein, the reflection angles are selected to minimize the coupling among the elastic FWI parameters, thereby simplifying the optimization process because the gradient of the objective function with respect to each of the elastic FWI parameters may exhibit reduced sensitivity to the other remaining elastic FWI parameters. Hence, a change in one parameter may no longer affect the gradient with respect to others parameters, making the inversion process better constrained and more computationally efficient.

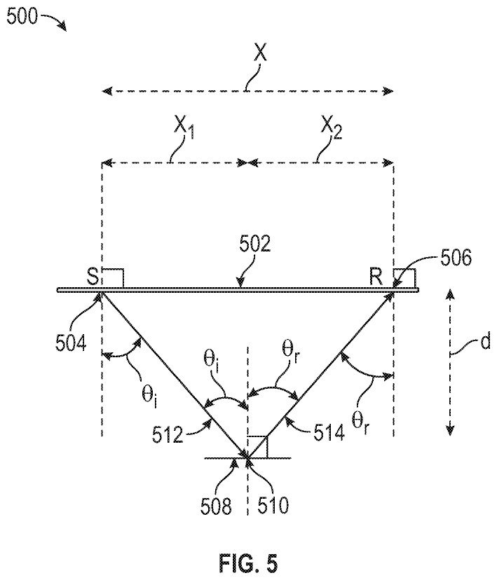

Referring now to FIG. 5, shown is an example of a subsurface model 500. In FIG. 5, a line 502 represents the surface at which one of the sources(S) and one of the receivers (R) are located. Further, in FIG. 5, a point 504 is where the source may be located on the surface 502 and a source elastic wavefield 512 is propagating from the source location 504 towards a subsurface 508. The source elastic wavefield 512 is reflected from the subsurface 508 at a reflection point 510. At the reflection point 510, the source elastic wavefield 512 makes an incident angle θᵢ with a normal to the subsurface 508 at the reflection point 510. Furthermore, a receiver elastic wavefield 514 is generated and propagated from the reflection point 510 towards the surface 502 after the source elastic wavefield 512 is reflected at the reflection point 510. The receiver may be located at a point 506 on the surface 502 and configured to receive the receiver elastic wavefield 514. The receiver elastic wavefield 514 may form a reflection angle θᵣ with the normal to the subsurface 508 at the reflection point 510. For example, based on Snell's law and for the P-waves, for a given incident angle (θᵢ), the reflection angle (θᵣ) is always equal to θᵢ, and a horizontal distance (X=X₁+X₂) between the source and the receiver (i.e., offset) at which this reflection occurs may be depend on Or and a depth of the subsurface (d) and satisfies the following equations:

$${X}_{1} = d tan ( {θ}_{i} ) ; \qquad ( 1 )$$

$${X}_{2} = d tan ( {θ}_{r} ) ; \qquad ( 2 )$$

$$Since , {θ}_{i} = {θ}_{r} ; \qquad ( 3 )$$

$${X}_{1 +} {X}_{2} = X = 2 d tan ( {θ}_{r} ) . \qquad ( 4 )$$

As can be seen from above description, the propagation directions of the source elastic wavefield and the receiver elastic wavefield are important for determining the reflection angle θᵣ. There may be several methods such as an Optical Flow method, FFT based method, or Poynting vector method that can be used to obtain the propagation directions of the source elastic wavefield and the receiver elastic wavefield.

In an embodiment, one way to obtain the propagation directions is by solving the Optical Flow equation. The Optical Flow equation in the context of wavefield propagation may be derived by adapting the concept of optical flow to seismic wavefields. For seismic waves, the Optical Flow equation may be represented as:

$$\frac{\partial u ( x , t )}{\partial t} + ∇ u ( x , t ) \cdot \vec{v} = 0 \qquad ( 5 )$$

where u(x, t) is the seismic wavefield (e.g., the source elastic wavefield or the receiver elastic wavefield) at position x, and time t and represents any of particle displacement, pressure, or another relevant quantity, ∇u(x, t) is the spatial gradient of the wavefield that indicates a change in the wavefield in space (that is with respect to position), and i′ is the wavefield velocity vector indicating the speed and direction in which the wave is propagating in 3D space. The first term of equation (5)

$$( \frac{\partial u ( x , t )}{\partial t} )$$

indicates the wavefield evolvement over time. The second term of equation (5) (∇u(x, t). \vec{v}) indicates the change in the displacement field in the wave propagation direction. Solving equation (5) using numerical methods such as finite difference methods or finite element methods may yield an estimation of the velocity field \vec{v}, which indicates the propagation directions and speeds of the seismic waves at each point in space. The reflection angle θᵣ may then be obtained by solving the following equation:

$$cos ( 2 {θ}_{r} ) = \frac{\vec{a} \cdot \vec{b}}{\vert \vec{a} \vert \cdot \vert \vec{b} \vert} \qquad ( 6 )$$

where \vec{a} represents the source elastic wavefield and \vec{b} represents the receiver elastic wavefield obtained by solving equation (5).

In another embodiment, the propagation directions may be obtained by using the FFT method along with the source elastic wavefield and the receiver elastic wavefield. In this process, the FFT may be applied to each of the source elastic wavefield and the receiver elastic wavefield to transform the source elastic wavefield and the receiver elastic wavefield from the time domain to frequency or wavenumber domain and obtain an FFT output. The FFT output from the previous step results in a 3D array of spatial frequencies F(kₓ, k_{y}, k_{z}). Then the dominant spatial frequency components which have the highest amplitudes in the FFT output may be identified and used to obtain the wave vector \vec{k}=(kₓ, k_{y}, k_{z}). The propagation direction corresponds to the angle of the wave vector in the spatial frequency domain, and the magnitude of the wave vector is related to the wavelength of the wave. For example, the wave vector magnitude |\vec{k}| is:

$$\vert \vec{k} \vert = \sqrt{{k}_{x}^{2} + {k}_{y}^{2} + {k}_{z}^{2}} \qquad ( 7 )$$

The propagation direction of a wavefield is then determined by the direction of the wave vector. Further, the angles of propagation in each of the three spatial dimensions (relative to the coordinate axes) can be found from the components of the wave vector:

$$The angle relative to the x - axis ( {θ}_{x} ) = {cos}^{- 1} ( \frac{{k}_{x}}{\vert \vec{k} \vert} ) \qquad ( 8 )$$

$$The angle relative to the y - axis ( {θ}_{y} ) = {cos}^{- 1} ( \frac{{k}_{y}}{\vert \vec{k} \vert} ) \qquad ( 9 )$$

$$The angle relative to the z - axis ( {θ}_{z} ) = {cos}^{- 1} ( \frac{{k}_{z}}{\vert \vec{k} \vert} ) \qquad ( 10 )$$

The propagation direction is thus given by the vector \vec{k}=(k_{y}, k_{y}, k_{z}), and the direction angles (θₓ, θ_{y}, θ_{z}) may specify how the wave propagates in the x, y, and z directions, respectively.

In another embodiment, the propagation directions may be obtained by using a Poynting vector method. The Poynting vector describes the energy flux of a wave and indicates the propagation direction. In the context of seismic waves, the Poynting vector may be related to the displacement vector (i.e., the particle motion in the medium) and the stress tensor that describes internal forces in the medium for seismic waves. The Poynting vector points in the direction of energy flow, which coincides with the wave propagation direction, providing a clear indicator of where the wave is propagating.

In seismic waves, for example, the Poynting vector is aligned with the wave vector, indicating the direction of the seismic wave's energy transfer. Thus, the Poynting vector may be used to determine the propagation direction of seismic waves by analyzing how energy flows through the medium.

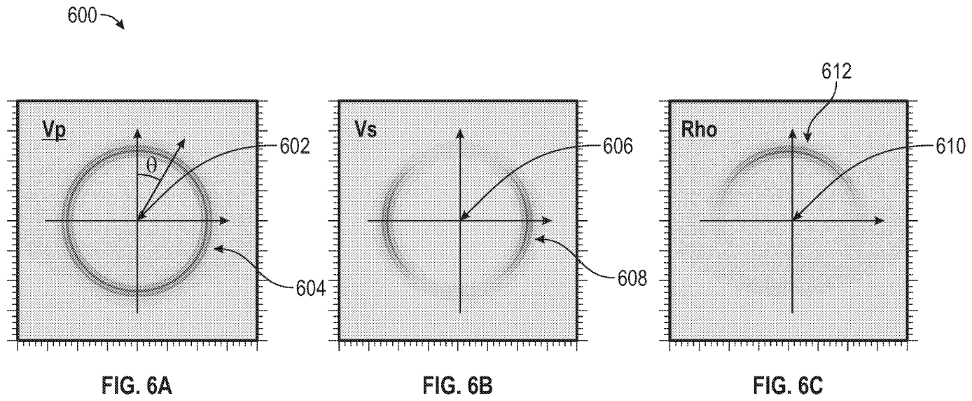

Referring now to FIGS. 6A-6C, shown are images 600 depicting radiation patterns for the elastic FWI parameters as a function of the source-receiver angle (θ), where “source-receiver angle” herein may refer to the angle between the propagation direction of the source elastic wavefield and the propagation direction of the receiver elastic wavefield calculated at each location of a subsurface model. The source-receiver angle may also refer to the angle formed between the incident seismic wave and the reflected seismic wave at the point of reflection. Furthermore, based on the definition of the reflection angle (θᵣ) as half the angle formed between the incident seismic waves and the reflected seismic wave at the point of reflection, the source-receiver angle (θ) is twice the reflection angle (e.g., θ=2θᵣ) in the case of an incident P-wave and reflected P-wave. Specifically, FIG. 6A illustrates a radiation pattern for P-wave velocity (Vp) as a function of the source-receiver angles in the elastic FWI process, FIG. 6B depicts a radiation pattern for S-wave velocity (Vs) as a function of the source-receiver angles in the elastic FWI process, and FIG. 6C depicts a radiation pattern for density (ρ) as a function of the source-receiver angles in the elastic FWI process.

Turning first to FIG. 6A, shown is a radiation pattern for Vp as a function of the source-receiver angles in the elastic FWI process. In FIG. 6A, a source may be placed at the top of FIG. 6A with a point scatterer in Vp, which may be created by introducing a small perturbation in the value of Vp at a single point in the model, at location 602 in a subsurface model, resulting in scattering of the source elastic wavefield all directions throughout the subsurface model. The scattering response or the radiation pattern of Vp may be observed in graph 604. The scattering response or the radiation pattern of Vp shown in graph 604 illustrates the sensitivity of Vp, or how the seismic wavefield responds as a function of source-receiver angle when a small change is made to Vp. In the example shown in graph 604, if a small change is made to Vp, the seismic wavefield would be affected/changed at all source-receiver angles (i.e., this example illustrates Vp being sensitive at all source-receiver angles).

In this way, the graph 604 indicates that the sensitivity of the wavefield to Vp may be isotropic for all source-receiver angles, i.e., source elastic wavefields and receiver elastic wavefields would exhibit a response in all directions when encountering a change in Vp. Furthermore, Vp indicating isotropic behavior in this particular example may provide the information that the Vp may be coupled or suffer from cross-dependency with other elastic FWI parameters at source-receiver angles where sensitivities or radiation patterns of the other elastic FWI parameters may overlap.

Turning now to FIG. 6B, shown is a radiation pattern for Vs as a function of the source-receiver angles in the elastic FWI process. In FIG. 6B, a source may be placed at the top of FIG. 6B with a point scatterer in Vs at location 606 in a subsurface model, resulting in the source elastic wavefields scattering in all directions throughout the subsurface model. The scattering response or the radiation pattern of Vs may be observed in graph 608. The scattering response or the radiation pattern of Vs shown in graph 608 illustrates the sensitivity of Vs, or how the seismic wavefield responds as a function of source-receiver angle when a small change is made to Vs. In the example shown in graph 608, if a small change is made to Vs, the seismic wavefield would be affected/changed at the source-receiver angles highlighted in graph 608 (i.e., this example illustrates Vs being sensitive only at the source-receiver angles shown in graph 608).

In this way, the graph 608 indicates that the sensitivity of the wavefield to changes in Vs may be directional with source-receiver angle. For example, for the corresponding subsurface model, Vs may be sensitive to mid-angles ranging from 45°-135° (the source-receiver angles highlighted in graph 608). The sensitivity of Vs to angles in the range of 45°-135° indicates that the wavefield has greater directional dependency to a variation in the Vs wave velocity at these angles. This information may be used to select a subset of the wavefield to emphasize when inverting for Vs in the elastic FWI process.

Turning finally to FIG. 6C, shown is a radiation pattern for ρ as a function of the source-receiver angles in the elastic FWI process. In FIG. 6C, a source may be placed at the top of FIG. 6C with a point scatterer in ρ at location 610 in a subsurface model, resulting in scattering of the source elastic wavefield in all directions throughout the subsurface model. The scattering response or the radiation pattern of ρ may be observed in graph 612. The scattering response or the radiation pattern of ρ shown in graph 612 illustrates the sensitivity of ρ, or how the seismic wavefield responds as a function of source-receiver angle when a small change is made to ρ. In the example shown in graph 612, if a small change is made to ρ, the seismic wavefield would be affected/changed at the source-receiver angles highlighted in graph 612 (i.e., this example illustrates ρ being sensitive only at the angles shown in graph 612—sometimes referred to as near angles, which references the fact that these angles are near 0°).

In this way, the graph 612 indicates that the sensitivity to ρ may be directional with source-receiver angle. Therefore, for the corresponding subsurface model, ρ may be sensitive to near angles ranging from 0-30° (the source-receiver angles highlighted in graph 612). This observation may indicate that when the source-receiver angle is between 0° and 30°, the wavefield may become particularly sensitive to the density (ρ) of the subsurface materials. Note also that at near source-receiver angles, the reflected seismic waves may also be influenced by Vp, indicating that the acoustic impedance, which is as specified before, the product of density and P-wave velocity, affects the near-angle wavefield response. In such cases, small changes in density may cause significant variations in the amplitude and character of the reflected waves, as the angle of incidence is very small. This range of source-receiver angles (0°-30°) may be especially sensitive to variations in density because the seismic reflection coefficients may be more strongly affected by density contrasts at these angles, as the seismic waves propagate almost perpendicular to the boundary layers.

In this way, term “sensitivity” as used herein may refer to the degree to which variations in Vp, Vs, and/or ρ influence the seismic signals observed during reflection, scattering, or transmission events. At these angles, even small changes in the elastic FWI parameters (e.g., Vp, Vs, and/or ρ) may result in more noticeable variations in the recorded seismic signals. Therefore, the data collected at certain angles may be more informative or “sensitive” for detecting and inverting for the elastic FWI parameters (e.g., Vp, Vs, and/or ρ).

When inverting for elastic parameters through the elastic FWI process, a suitable range of limited source-receiver angles for each of the elastic FWI parameters (e.g., Vp, Vs, and/or ρ) may be selected (e.g., by the processor 64 of the computing system 60) based on the scattering response or the radiation pattern of the elastic FWI parameters (e.g., Vp, Vs, and/or ρ) observed in graphs 604, 608, and 612. In an embodiment, the limited range of source-receiver angles for each respective elastic FWI parameter (e.g., Vp, Vs, or ρ) may be selected to minimize angle sensitivity overlap with other elastic FWI parameters (Vp, Vs, and ρ). By minimizing the angle sensitivity overlap across the elastic FWI parameters (Vp, Vs, and ρ), ambiguity in the seismic data with respect to different elastic parameters may be reduced, and in turn improves the accuracy of the elastic parameter models recovered through the elastic FWI process.

First, the limited range of source-receiver angles for Vp may be selected based on the sensitivity data for the elastic FWI parameters (e.g., Vp, Vs, and/or ρ) observed in graphs 604, 608, and 612. For example, the limited range of source-receiver angles for Vp may be selected to be angles only greater than 90° (sometimes referred to as far-angles). This follows from the observation that Vs and ρ exhibit a weaker response or sensitivity at angles greater than 90° (as indicated in graphs 608 and 612)—thereby minimizing the angle sensitivity overlap with other elastic FWI parameters (Vs and ρ). Therefore, by selecting angles only greater than 90° as the range of source-receiver angles for Vp, it is possible to minimize coupling with Vs and ρ, thereby reducing ambiguity in the seismic data as it is used during the elastic FWI process.

Next, the limited range of source-receiver angles for Vs may be determined based on the sensitivity data to the elastic FWI parameters (e.g., Vp, Vs, and/or ρ) observed in graphs 604, 608, and 612. For example, the limited range of source-receiver angles for Vs may be selected to be angles only in the range of 45°-90° (sometimes referred to as mid-angles). This may be because Vs has a strong sensitivity at angles in the range of 45°-90° and ρ does not appear to have a strong response or sensitivity at angles in the range of 45°-90° (as indicated in graph 612)—thereby minimizing the angle sensitivity overlap with other elastic FWI parameters. Therefore, by selecting angles only in the range of 45°-90° as the range of source-receiver angles for Vs, it is possible to minimize coupling with Vp and ρ, thereby reducing ambiguity in the seismic data during the elastic FWI process.

Lastly, the limited range of source-receiver angles for ρ may be selected based on the sensitivity data for the elastic FWI parameters (e.g., Vp, Vs, and/or ρ) observed in graphs 604, 608, and 612. For example, the limited range of source-receiver angles for ρ may be determined to be angles only in the range of 0°-30° (sometimes referred to as near angles). This may be because ρ has a strong sensitivity at angles in the range of 0°-30° and Vs does not appear to have a strong response or sensitivity at angles in the range of 0°-30° (as indicated in graph 608)—thereby minimizing the angle sensitivity overlap with other elastic FWI parameters. Therefore, by selecting angles only in the range of 0°-30° as the range of source-receiver angles for ρ, it is possible to minimize coupling with Vp and ρ, thereby reducing ambiguity in the seismic data during the elastic FWI process

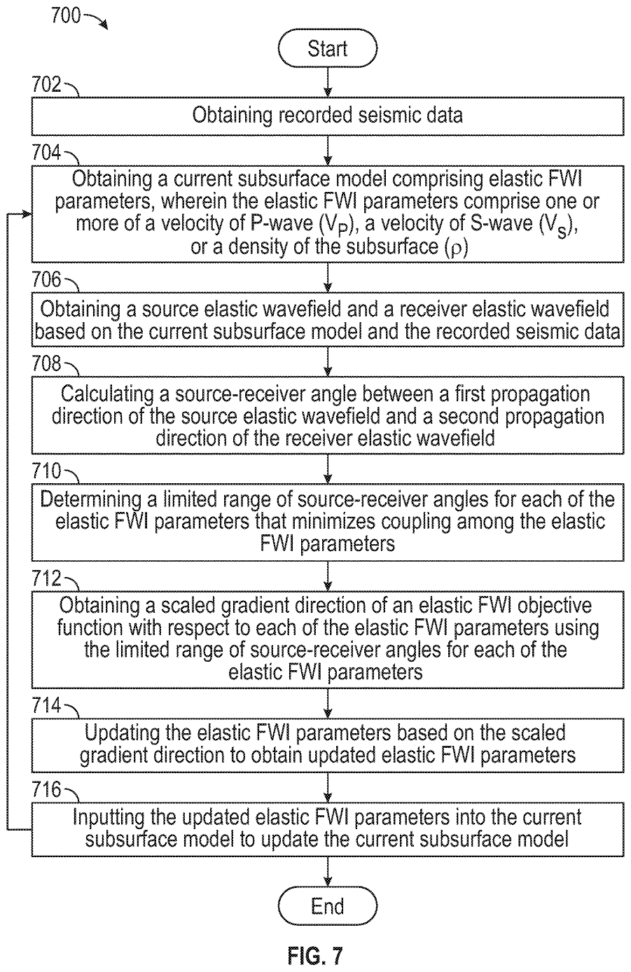

Referring now to FIG. 7, shown is a flowchart of an embodiment of a method for generating angle dependent imaging condition for multi-parameter elastic FWI according to various embodiments of the disclosure. At least some, if not all, of the steps of method 700 shown in FIG. 7 may be executed by the computing system 60 shown in FIG. 4, although it may be understood that at least some of the steps of method 700 may be executed by systems other than computing system 60. Additionally, it may be understood that the migration of seismic data described by method 700 may be used for a variety of purposes, including volumetric analysis and in the planning hydrocarbon exploration, which would extend through the subsurface region. Thus, method 700 may be used in the process of generating final seismic data including final migrated seismic data, which may include, for example, final migrated seismic gathers and/or one or more final stacked seismic images of the subsurface region.

Beginning at step 702, method 700 comprises obtaining, by the computing system 60, recorded seismic data. The recorded seismic data may be generated by the sources such as source 32 shown in FIG. 2 or source 40 shown in FIG. 3. These sources may include artificial seismic sources, such as explosions, vibroseis trucks, or weight drops, and are configured to generate seismic waves that propagate through the subsurface. These seismic waves are then recorded by receivers such as the receivers 36 shown in FIG. 2 or the receivers 44 and 46 shown in FIG. 3. The recorded seismic data may include the arrival times, amplitudes, and frequencies of the seismic waves, which are affected by the different layers in the subsurface that they may have encountered during the propagation, reflection, and/or refraction. The recorded seismic data provide valuable information about the subsurface structure, including rock formations, faults, and potential resources like oil and gas.

In an embodiment, the computing system 60 may directly acquire the recorded seismic data from the receivers, such as receivers 36, 44, and 46, shown in FIG. 2 and FIG. 3. Alternatively, the receivers may store the recorded seismic data in the database 74, from which the computing system 60 may retrieve the recorded seismic data.

At step 704, method 700 comprises obtaining, by the computing system 60, a current subsurface model comprising elastic FWI parameters. The elastic FWI parameters may include one or more of a velocity of P-wave (V_{P}), a velocity of S-wave (V_{S}), or a density of the subsurface (ρ). In the elastic FWI process, a variety of elastic parameters may be used to construct a detailed subsurface model, enabling the characterization of subsurface materials and their behavior under seismic waves. In some embodiments, only the primary elastic parameters such as Vₚ, Vₛ, and ρ are used. However, there may be many possible choices of parameters such as shear modulus (μ) and bulk modulus (K), which provide insights into the subsurface response to shear and compressional stresses, respectively, and Lamé parameters (λ and μ), which offer a comprehensive description of the subsurface elastic properties. Poisson's ratio (v) may be another parameter that indicates the subsurface deformation characteristics under stress. In cases of anisotropic media, parameters that describe the directional dependency of wave propagation, such as the Thomsen parameters, may be used. Moreover, attenuation parameters (Q-factor) may be included to account for energy loss during wave propagation, and anisotropy parameters (epsilon, delta, gamma) may be included to account for seismic anisotropy to describe the directional dependence of seismic velocities. Together, these parameters may enable a comprehensive understanding of subsurface properties and as such, be used for accurate seismic imaging and inversion in geophysical studies.

The process of obtaining the current subsurface model using elastic FWI begins with an initial model, which provides the starting point for the elastic FWI inversion process. During the first iteration, the computing system 60, may generate an initial subsurface model based on prior knowledge or assumptions about V_{P}, V_{S}, and ρ of the subsurface. Further, for the first iteration, the initial subsurface model may be the current subsurface model. The initial/current subsurface model may be expressed as a function of position \vec{x}=(x, y, z) in 3D space. Furthermore, V_{P}=V_{P}(\vec{x}), V_{S}=V_{S}(\vec{x}), and ρ=ρ(x). Therefore, the initial/current subsurface model M (x) may be represented as:

$$M ( \vec{x} ) = \{ {V}_{p} ( \vec{x} ) , {V}_{s} ( \vec{x} ) , ρ ( \vec{x} ) \} \qquad ( 11 )$$

At step 706, method 700 comprises obtaining, by the computing system 60, a source elastic wavefield and a receiver elastic wavefield based on the current subsurface model. In an embodiment, by simulating the propagation of seismic waves through the subsurface using the initial/current subsurface model shown in equation (11), the source elastic wavefield and the receiver elastic wavefield may be obtained. In an embodiment, the source elastic wavefield may refer to the seismic wavefield generated by forward-time simulating the source such as a source located at position 504 in FIG. 5, while the receiver elastic wavefield may correspond to the seismic wavefield generated by backward-time simulating the data recorded by receivers located at various positions, for example a receiver located at position 506 on the surface such as the surface 502 in FIG. 5. The source elastic wavefield may be generated by inputting a source wavelet \vec{s}(\vec{xₛ}, t) that models the seismic source into the elastic wave equation at the source location. The forward modeling process for obtaining the source elastic wavefield may be performed by applying the elastic wave equation in the time domain:

$$ρ ( \vec{x} ) \frac{{\partial }^{2} \vec{u} ( \vec{x} , t )}{\partial {t}^{2}} = ∇ \cdot σ ( \vec{x} ) + \vec{s} ( \vec{{x}_{s}} , t ) \qquad ( 12 )$$

where \vec{u}(\vec{x}, t) is the displacement vector at position \vec{x}, time t, σ(\vec{x}) is the stress tensor that related to the displacements, and \vec{s}(\vec{xₛ}, t) is the source wavelet.

By solving the elastic wave equation (12) with the initial/current subsurface model equation (11), the source elastic wavefield and the modeled seismic data at the receivers may be obtained. In another embodiment, the difference between the recorded seismic data and the modeled seismic data indicates a misfit or residual between the current subsurface model and the real subsurface. By backpropagating the residuals from the receiver positions, the receiver elastic wavefields may be obtained. Backpropagation may involve solving the adjoint wave equation, which propagates the residuals backwards in time from the receiver positions towards the source location. This is similar to the way the source wavefield propagates forward through the subsurface during the forward modeling process. Herein, the adjoint wave equation may be represented by:

$$ρ ( \vec{x} ) \frac{{\partial }^{2} \vec{{u}_{A}} ( \vec{x} , t )}{\partial {t}^{2}} = ∇ \cdot {σ}_{A} ( \vec{x} ) + \vec{r} ( {\vec{x}}_{r} , t ) \qquad ( 13 )$$

where \vec{u_{A}}(\vec{x}, t) is the adjoint displacement field (the backpropagated wavefield) at position \vec{x}, time t, σ_{A}(\vec{x}) is the adjoint stress tensor, and \vec{r}(\vec{xᵣ}, t) is the residual term that acts as the source in the adjoint equation. By solving the adjoint wave equation (13) with the initial/current subsurface model equation (11), the receiver elastic wavefield may be obtained.

At step 708, method 700 involves calculating, by the computing system 60, the source-receiver angle between a first propagation direction of the source elastic wavefield and a second propagation direction of the receiver elastic wavefield. In an embodiment, the calculation of the propagation directions for the source and receiver elastic wavefields, obtained in step 706, can be performed using methods such as the Optical Flow equation, the FFT method, or the Poynting vector approach described in FIG. 5. These methods are not reiterated here for brevity.

At step 710, method 700 involves determining, by the computing system 60, a limited range of source-receiver angles for each of the elastic FWI parameters that minimizes coupling among these parameters. Specifically, determining a limited range of source-receiver angles for each of the elastic FWI parameters (Vp, Vs, and density) involves selecting specific angles at which the sensitivity of each parameter is maximized while minimizing interference or coupling between them. This process may isolate the influence of each parameter on the recorded seismic data. By focusing on a narrow range of source-receiver angles, the computing system 60 may reduce the cross-dependency or coupling that may occur when multiple parameters simultaneously influence the seismic signals and thereby improving the accuracy and stability of the inversion process. Prior to performing step 710, a sensitivity analysis may be conducted on the current subsurface model to obtain radiation patterns for the elastic FWI parameters as a function of the source-receiver angle, as illustrated in FIGS. 6A-6C. In one embodiment, step 710 may be executed in conjunction with obtaining the radiation patterns for the elastic FWI parameters as a function of the source-receiver angles. After completing step 710, the limited range of source-receiver angles for each elastic FWI parameter that minimizes coupling can be identified. In an embodiment, determining the limited range of source-receiver angles for P-wave velocity (V_{P}) involves selecting the first range of angle (θ_{P}) from a first range, based on the radiation pattern for V_{P} as a function of angle, as shown in FIG. 6A. For example, the first range may include angles greater than 90° (or far-angles) such that the influence from other parameters are minimum. In another embodiment, determining the limited range of source-receiver angles for S-wave velocity (V_{S}) includes selecting the second range of angles (θ_{S}) from a second range, based on the radiation pattern for V_{S} depicted in FIG. 6B. For example, the second range may be between 45° and 90° (or mid-angles) for θ_{S}. Furthermore, determining the limited range of source-receiver angles for density (ρ) involves selecting the third range of angles (θρ) from a third range, based on the radiation pattern for ρ as a function of the angles shown in FIG. 6C. For example, the third range may be between 0° and 30° (or near-angles) for θρ. The selection of these limited angle ranges—first, second, and third—may be designed to minimize overlap between the radiation patterns of the elastic FWI parameters, thereby reducing parameter coupling and enhancing accuracy and computational efficiency in the elastic FWI process.

At step 712, the method 700 comprises obtaining, by the computing system 60, a scaled gradient direction of an elastic FWI objective function with respect to each of the elastic FWI parameters using the limited range of source-receiver angles for each of the elastic FWI parameters. The term “scaled gradient direction” specified herein may refer to the direction in which the elastic FWI parameters may be adjusted to minimize the mismatch between the recorded seismic data and the modeled seismic data, with the gradient of the objective function being appropriately scaled. Specifically, obtaining the scaled gradient direction of the elastic FWI objective function with respect to each of the elastic FWI parameters involves determining the direction in which to update each elastic parameter to reduce the difference (or misfit or residual) between the modeled seismic data and the recorded seismic data.

The objective function in FWI may measure the difference (or misfit or residual) between the modeled seismic data generated from the current subsurface model and the recorded seismic data. The objective is to minimize this residual by iteratively adjusting the elastic FWI parameters. The gradient of this function with respect to each model parameter indicates how the objective function changes as each parameter is adjusted.

Furthermore, in order to obtain the gradient with respect to each parameter, the elastic FWI process uses the principles of seismic wave propagation. In an embodiment, the gradient may be the sensitivity of the seismic response to changes in the subsurface parameters Vₚ, Vₛ, and ρ. Therefore, to ensure that the elastic FWI process converges efficiently, these gradients are often scaled using a step length.

In an embodiment, the step length may be obtained using a line search method by iteratively evaluating the objective function along a given search direction (usually the negative gradient direction, conjugate gradient direction, and Limited-memory Broyden-Fletcher-Goldfarb-Shanno (L-BFGS), etc) and adjusting the step size to find the optimal value that minimizes the objective function. The line search method may be performed using methods like Armijo's rule or Wolfe conditions. In Armijo's rule, the step length is reduced incrementally until a sufficient decrease in the objective function is achieved. Wolfe conditions refine this process by additionally making the slope of the objective function along the search direction not too steep, ensuring stable progress. The resulting step length may guide the update of the elastic FWI parameters in each iteration of the optimization process.

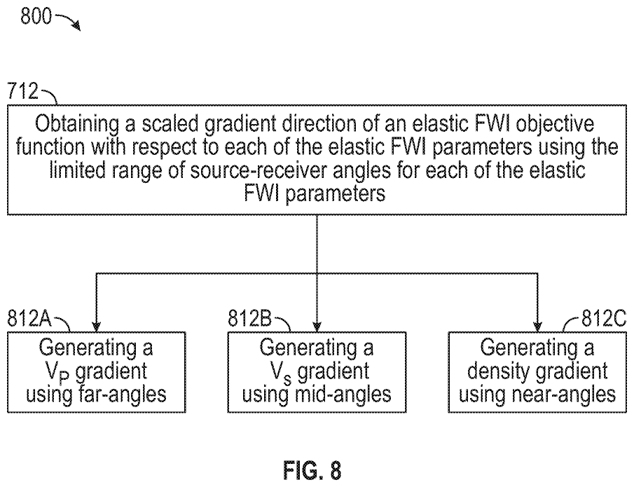

The scaling process adjusts the magnitude of the gradient to account for differences in the units, range of values, or sensitivity of the elastic FWI parameters and balance the influence of each of the elastic FWI parameters on the elastic FWI process, ensuring that each parameter contributes optimally to minimizing the objective function. Furthermore, the current subsurface model is dependent on Vₚ, Vₛ, and ρ, and therefore the gradient of the objective function with respect to each model parameter includes calculating of three different gradients as shown in FIG. 8.

Referring now to FIG. 8, shown is the method 800 of generating angle dependent imaging condition for multi-parameter elastic FWI according to various embodiments described herein. At least some, if not all, of the steps of method 800 shown in FIG. 8 may be executed by the computing system 60 shown in FIG. 4, although it may be understood that at least some of the steps of method 800 may be executed by systems other than computing system 60. Additionally, it may be understood that the migration of seismic data described by method 800 may be used for a variety of purposes, including volumetric analysis and in the planning hydrocarbon exploration, which would extend through the subsurface region. Thus, method 800 may be used in the process of generating final seismic data including final migrated seismic data, which may include, for example, final migrated seismic gathers and/or one or more final stacked seismic images of the subsurface region.

Beginning at step 712, the method 800 comprising obtaining, by the computing system 60, a scaled gradient direction of an elastic FWI objective function with respect to each of the elastic FWI parameters using the limited range of source-receiver angles for each of the elastic FWI parameters. This step 712 in method 800 is the same step 712 in method 700. Furthermore, step 712 in method 800 includes three subsequent steps: 812A, 812B, and 812C that may be performed simultaneously or sequentially.

At step 812A, the method 800 includes generating a Vp gradient, by the computing system 60, using far-angles. At step 812B, the method 800 includes generating, by the computing system 60, a Vs gradient using mid-angles. At step 812C, the method 800 includes generating, by the computing system 60, a density gradient using near-angles.

The following equations may be used to generate a Vp gradient using far-angles, a Vs gradient using mid-angles, and a density gradient using near-angles:

$$\frac{\partial E}{\partial λ} = - {\sum }_{sources} \int dt ( \frac{\partial {u}_{x}}{\partial x} + \frac{\partial {u}_{z}}{\partial z} ) ( \frac{\partial {Ψ}_{x}}{\partial x} + \frac{\partial {Ψ}_{z}}{\partial z} ) ; \qquad ( 14 )$$

$$\frac{\partial E}{\partial μ} = - {\sum }_{sources} \int dt ( \frac{\partial {u}_{x}}{\partial z} + \frac{\partial {u}_{z}}{\partial x} ) ( \frac{\partial {Ψ}_{x}}{\partial z} + \frac{\partial {Ψ}_{z}}{\partial x} ) + 2 ( \frac{\partial {u}_{x}}{\partial x} \frac{\partial {Ψ}_{x}}{\partial x} + \frac{\partial {u}_{z}}{\partial z} \frac{\partial {Ψ}_{z}}{\partial z} ) ; \qquad ( 15 )$$

$$\frac{\partial E}{\partial ρ} = - {\sum }_{sources} \int d t ( \frac{{\partial }^{2} {u}_{x}}{\partial {t}^{2}} {Ψ}_{x} + \frac{{\partial }^{2} {u}_{z}}{\partial {t}^{2}} {Ψ}_{z} ) ; \qquad ( 16 )$$

$$( \frac{\partial E}{\partial {V}_{p}} ) = 2 ρ {V}_{p} ( \frac{\partial E}{\partial λ} ) ; \qquad ( 17 )$$

$$( \frac{\partial E}{\partial {V}_{S}} ) = - 4 ρ {V}_{S} ( \frac{\partial E}{\partial λ} ) + 2 ρ {V}_{S} ( \frac{\partial E}{\partial μ} ) ; and \qquad ( 18 )$$

$$( \frac{\partial E}{\partial p} ) = ( {V}_{P}^{2} - 2 {V}_{S}^{2} ) ( \frac{\partial E}{\partial λ} ) + {V}_{S}^{2} ( \frac{\partial E}{\partial μ} ) + 2 ρ {V}_{S} ( \frac{\partial E}{\partial ρ} ) \qquad ( 19 )$$

where E represents the elastic FWI objective function, Vp represents P-wave velocity, Vs represents S-wave velocity, ρ represents density of the elastic material, λ and μ represent Lamé parameters,

$$\frac{\partial E}{\partial {V}_{p}}$$

represents Vp gradient using far-angles,

$$\frac{\partial E}{\partial {V}_{S}}$$

represents Vs gradient using mid-angles,

$$\frac{\partial E}{\partial p}$$

represents density gradient using near-angles, u=W(θ) (uₓ, u_{z}) represents an angle restricted source elastic wavefield, and Ψ=W(θ) (Ψₓ, Ψ_{z}) represents an angle restricted receiver elastic wavefield.

In an embodiment the source elastic wavefield obtained in step 706 of method 700 may be modified with a weighting function W(θ) corresponding to the limited range of source-receiver angles to obtain the angle restricted source elastic wavefield. In another embodiment the receiver elastic wavefield obtained in step 706 of method 700 may be modified with the same weighting function W(θ) corresponding to the limited range of source-receiver angles to obtain the angle restricted receiver elastic wavefield. In another embodiment, the weighting function W (e) may be a function of source-receiver angles and the weighting function W(θ) may be conditionally computed using the following equations:

When being used to obtain far-angles:

$$W ( θ ) = \{ \begin{matrix}1 , & θ > 90 ° \\ 0 , & θ \leq 90 °\end{matrix} ; \qquad ( 20 )$$

When being used to obtain mid-angles:

$$W ( θ ) = \{ \begin{matrix}1 , & 45 ° < θ < 90 ° \\ 0 , & θ \leq 45 ° and θ \geq 90 °\end{matrix} ; and \qquad ( 21 )$$

When being used to obtain near-angles:

$$W ( θ ) = \{ \begin{matrix}1 , & 0 < θ < 30 ° \\ 0 , & θ \geq 30 °\end{matrix} . \qquad ( 22 )$$

This weighting function W(θ) may serve to emphasize or de-emphasize certain angles based on their relevance to the inversion process. By restricting the range of angles, the method may focus on the most sensitive regions where the seismic data may be most informative for the specific elastic parameters being inverted. The weighting function W(θ)) may adjust the wavefield in such a way that data from angles outside of the selected range have less influence on the inversion, thereby reducing potential noise or unwanted coupling effects. This angle-restricted wavefield may improve the accuracy and stability of the inversion by minimizing the impact of less relevant or less sensitive data.

As discussed above, the limited range of source-receiver angles for each of the elastic FWI parameters that are determined at step 710 may be used to reduce the coupling among parameters and improve the efficiency of the inversion. These source-receiver angles may define the directions of propagation of seismic waves for each of the elastic FWI parameters, which may be selected based on the sensitivity analysis and radiation patterns of the elastic FWI parameters with respect to different source-receiver angles. By selecting the limited range of source-receiver angles, the FWI process may be focused on those parts of the seismic data that are most sensitive to the elastic FWI parameter in question. For example, certain source-receiver angles may be more sensitive to P-wave velocity than to density or S-wave velocity. By executing step 710 with reference to the examples shown and described in FIGS. 6A-6C it is found that for a subsurface model, having source-receiver angles greater than 90° or far-angles for P-wave velocity (V_{P}), source-receiver angles between 45° and 90° or mid-angles for S-wave velocity (V_{S}), and source-receiver angles between 0° and 30° or near-angles for density (ρ) may yield the lowest coupling among elastic FWI parameters. In an embodiment, the specific range of source-receiver angles and the form of weighting functions may vary depending on the subsurface characteristics. These source-receiver angles and the weighting functions are not fixed and may be influenced by factors such as the geological properties, seismic velocities, and the type of waves being considered. As such, deviations from the ranges and functions described in the text may occur, and any adjustments may be made based on the specific subsurface conditions to ensure more accurate modeling and interpretation of seismic data. These limited ranges of source-receiver angles for each of the elastic FWI parameters can be incorporated into the source elastic wavefields and the receiver elastic wavefields using the weighting functions W(θ) indicated in equations (20)-(22).

Referring now again back to FIG. 7, the step 714 in method 700 includes updating, by the computing system 60, the elastic FWI parameters based on the scaled gradient direction to obtain updated elastic FWI parameters. In an embodiment, updating the elastic FWI parameters involves adjusting the elastic FWI parameters, such as Vₚ, Vₛ, and ρ, based on the scaled gradient direction to improve the fit between the modeled seismic data and the recorded seismic data. The computing system 60 may calculate the gradient of the elastic FWI objective function with respect to the elastic FWI parameters, indicating the direction in which each of the elastic FWI parameter needs to be updated to reduce the residual. These gradients may then be scaled to balance the influence of each of the elastic FWI parameters, ensuring that no single parameter dominates the update process. The computing system 60 may then use the scaled gradient direction to determine the appropriate adjustment for each parameter and update each of the elastic FWI parameters to obtain updated elastic FWI parameters. The updating process may be performed by moving the elastic FWI parameters in the direction of the negative scaled gradient, with the previously determined step length to ensure that the adjustment effectively reduces the objective function.

Finally, at step 716, the method 700 comprises inputting, by the computing system 60, the updated elastic FWI parameters into the current subsurface model to update the current subsurface model. Specifically, the updated elastic FWI parameters obtained at step 714 may be used to update the current subsurface model and replace the current subsurface model with the updated current subsurface model. In an embodiment, the method 700 except for the step 702, may be iteratively performed for a fixed number of iterations. In another embodiment, the method 700 except for the step 702, may be iteratively performed until the elastic FWI objective function reaches a predefined magnitude that is less than a threshold.

In an embodiment, method 600 and/or 700 may further include performing a sensitivity analysis on each of the elastic FWI parameters with respect to source-receiver angles. In an embodiment, method 600 and/or 700 may further comprise adding, to each of the source elastic wavefield and the receiver elastic wavefield, a weighting function corresponding to the limited range of source-receiver angles to obtain an angle restricted source elastic wavefield and an angle restricted receiver elastic wavefield, and obtaining, based on the angle restricted source elastic wavefield and the angle restricted receiver elastic wavefield, gradients corresponding to each of the elastic FWI parameters. In an embodiment, one or more steps of methods 600 and/or 700 may be performed iteratively in a sequential order for a fixed number of iterations. In an embodiment, one or more steps of methods 600 and/or 700 may be performed iteratively in a sequential order until the elastic FWI objective function reaches a predefined magnitude that is less than a threshold. In an embodiment, methods 600 and/or 700 may further include selecting, for the limited range of source-receiver angles for V_{P}, first set of angles (θ_{P}) in a first range, wherein the first range is >90°, selecting, for the limited range of source-receiver angles for V_{S}, second set of angles (θ_{S}) in a second range, wherein the second range is 45°<θ_{S}<90°, and/or selecting, for the limited range of source-receiver angles for ρ, third set of angles (θβ) in a third range, wherein the third range is 0<θρ<30°.

In an embodiment, methods 600 and/or 700 may further include obtaining the first propagation direction and the second propagation direction based on an optical flow method. In an embodiment, methods 600 and/or 700 may further include obtaining the first propagation direction and the second propagation direction based on an FFT method. In an embodiment, methods 600 and/or 700 may further include obtaining the first propagation direction and the second propagation direction based on a Poynting vector method.

Furthermore, FWI here is defined to include all variants of full-waveform inversion. Certain examples of full-waveform inversion can use pressure and/or multi-component data. Certain examples of full-waveform inversion can use different approximations of physics (such as, for example, acoustic, elastic, visco-elastic, isotropic, and/or anisotropic). FWI can be used for different applications such as applications for estimating 3D velocities, applications for performing multi-parameter inversion, applications for deriving reflectivity volumes, applications for determining 4D difference volumes, applications for determining reflectivity gathers, and/or applications for determining probabilistic inversions, to name a few examples.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A method comprising:
(a) obtaining recorded seismic data;
(b) obtaining a current subsurface model comprising elastic full-waveform inversion (FWI) parameters, wherein the elastic FWI parameters comprise one or more of a velocity of P-wave (V_{P}), a velocity of S-wave (V_{S}), or a density of the subsurface (ρ);
(c) obtaining a source elastic wavefield and a receiver elastic wavefield based on the current subsurface model and the recorded seismic data;
(d) calculating a source-receiver angle between a first propagation direction of the source elastic wavefield and a second propagation direction of the receiver elastic wavefield;
(e) determining a limited range of source-receiver angles for each of the elastic FWI parameters that minimizes coupling among the elastic FWI parameters;
(f) obtaining a scaled gradient direction of an elastic FWI objective function with respect to each of the elastic FWI parameters using the limited range of source-receiver angles for each of the elastic FWI parameters;
(g) updating the elastic FWI parameters based on the scaled gradient direction to obtain updated elastic FWI parameters; and
(h) inputting the updated elastic FWI parameters into the current subsurface model to update the current subsurface model.

2. The method of claim 1, wherein before performing step (e), the method further comprises (i) performing a sensitivity analysis on each of the elastic FWI parameters with respect to source-receiver angles.

3. The method of claim 2, wherein after performing step (e) and before performing step (f), the method further comprises:
(j) adding, to each of the source elastic wavefield and the receiver elastic wavefield, a weighting function corresponding to the limited range of source-receiver angles to obtain an angle restricted source elastic wavefield and an angle restricted receiver elastic wavefield; and
(k) obtaining, based on the angle restricted source elastic wavefield and the angle restricted receiver elastic wavefield, gradients corresponding to each of the elastic FWI parameters.

4. The method of claim 3, further comprising iteratively repeating, in sequential order, steps (b)-(k) for a fixed number of iterations.

5. The method of claim 3, further comprising iteratively repeating, in sequential order, steps (b)-(k) until the elastic FWI objective function reaches a predefined magnitude that is less than a threshold.

6. The method of claim 1, wherein performing step (e) comprises:
selecting, for the limited range of source-receiver angles for V_{P}, first set of angles (θ_{P}) in a first range;
selecting, for the limited range of source-receiver angles for V_{S}, second set of angles (θ_{S}) in a second range; and
selecting, for the limited range of source-receiver angles for ρ, third set of angles (ep) in a third range,
wherein the first range, the second range, and the third range are different angle ranges.

7. The method of claim 1, further comprising obtaining the first propagation direction and the second propagation direction based on an optical flow equation method.

8. The method of claim 1, further comprising obtaining the first propagation direction and the second propagation direction based on a fast Fourier Transform (FFT) method.

9. The method of claim 1, further comprising obtaining the first propagation direction and the second propagation direction based on a Poynting vector method.

10. A computing system comprising:
a memory configured to store instructions; and
one or more processors coupled to the memory and configured to execute the instructions to cause the computing system to:
(a) obtain recorded seismic data;
(b) obtain a current subsurface model comprising elastic full-waveform inversion (FWI) parameters, wherein the elastic FWI parameters comprise one or more of a velocity of P-wave (V_{P}), a velocity of S-wave (V_{S}), or a density of the subsurface (ρ);
(c) obtain a source elastic wavefield and a receiver elastic wavefield based on the current subsurface model and the recorded seismic data;
(d) calculate a source-receiver angle between a first propagation direction of the source elastic wavefield and a second propagation direction of the receiver elastic wavefield;
(e) determine a limited range of source-receiver angles for each of the elastic FWI parameters that minimizes coupling among the elastic FWI parameters;
(f) obtain a scaled gradient direction of an elastic FWI objective function with respect to each of the elastic FWI parameters using the limited range of source-receiver angles for each of the elastic FWI parameters;
(g) update the elastic FWI parameters based on the scaled gradient direction to obtain updated elastic FWI parameters; and
(h) input the updated elastic FWI parameters into the current subsurface model to update the current subsurface model.

11. The computing system of claim 10, wherein before performing step (e), the one or more processors are further configured to execute the instructions to cause the computing system to (i) perform a sensitivity analysis on each of the elastic FWI parameters with respect to source-receiver angles.

12. The computing system of claim 11, wherein after performing step (e) and before performing step (f), the one or more processors are further configured to execute the instructions to cause the computing system to:
(j) add, to each of the source elastic wavefield and the receiver elastic wavefield, a weighting function corresponding to the limited range of source-receiver angles to obtain an angle restricted source elastic wavefield and an angle restricted receiver elastic wavefield; and
(k) obtain, based on the angle restricted source elastic wavefield and the angle restricted receiver elastic wavefield, gradients corresponding to each of the elastic FWI parameters.

13. The computing system of claim 12, wherein the one or more processors are further configured to execute the instructions to cause the computing system to iteratively repeat, in sequential order, steps (b)-(k) for a fixed number of iterations.

14. The computing system of claim 12, wherein the one or more processors are further configured to execute the instructions to cause the computing system to iteratively repeat, in sequential order, steps (b)-(k) until the elastic FWI objective function reaches a predefined magnitude that is less than a threshold.

15. The computing system of claim 10, wherein the one or more processors are further configured to execute the instructions to cause the computing system to:
select, for the limited range of source-receiver angles for V_{P}, first set of angles (θ_{P}) in a first range;
select, for the limited range of source-receiver angles for V_{S}, second set of angles (θ_{S}) in a second range; and
select, for the limited range of source-receiver angles for ρ, third set of angles (θ_{P}) in a third range,
wherein the first range, the second range, and the third range are different angle ranges.

16. The computing system of claim 10, wherein the one or more processors are further configured to execute the instructions to cause the computing system to obtaining the first propagation direction and the second propagation direction based on an optical flow equation method, a fast Fourier Transform (FFT) method, or Poynting vector method.

17. A computer program product comprising computer-executable instructions that are stored on a non-transitory computer-readable medium and that, when executed by one or more processors, cause a computing system to:
(a) obtain recorded seismic data;
(b) obtain a current subsurface model comprising elastic full-waveform inversion (FWI) parameters, wherein the elastic FWI parameters comprise a velocity of P-wave (V_{P}), a velocity of S-wave (V_{S}), and a density of the subsurface (ρ);
(c) obtain a source elastic wavefield and a receiver elastic wavefield based on the current subsurface model and the recorded seismic data;
(d) calculate a source-receiver angle between a first propagation direction of the source elastic wavefield and a second propagation direction of the receiver elastic wavefield;
(e) determine a limited range of source-receiver angles for each of the elastic FWI parameters that minimizes coupling among the elastic FWI parameters;
(f) obtain a scaled gradient direction of an elastic FWI objective function with respect to each of the elastic FWI parameters using the limited range of source-receiver angles for each of the elastic FWI parameters;
(g) update the elastic FWI parameters based on the scaled gradient direction to obtain updated elastic FWI parameters; and
(h) input the updated elastic FWI parameters into the current subsurface model to update the current subsurface model.

18. The computer program product of claim 17, wherein before performing step (e), the computer-executable instructions, when executed by the one or more processors, further cause the computing system to (i) perform a sensitivity analysis on each of the elastic FWI parameters with respect to source-receiver angles.

19. The computer program product of claim 18, wherein after performing step (e) and before performing step (f), the computer-executable instructions, when executed by the one or more processors, further cause the computing system to:
(j) add, to each of the source elastic wavefield and the receiver elastic wavefield, a weighting function corresponding to the limited range of source-receiver angles to obtain an angle restricted source elastic wavefield and an angle restricted receiver elastic wavefield; and
(k) obtain, based on the angle restricted source elastic wavefield and the angle restricted receiver elastic wavefield, gradients corresponding to each of the elastic FWI parameters.

20. The computer program product of claim 19, wherein the computer-executable instructions, when executed by the one or more processors, further cause the computing system to iteratively repeat, in sequential order, steps (b)-(k) for a fixed number of iterations or until the elastic FWI objective function reaches a predefined magnitude that is less than a threshold.
